(19) United States
(12) Patent Application Publication
(10) Pub. No.: US 2021/0337441 A1
(43) Pub. Date: Oct. 28, 2021

(54) MOBILITY INTERRUPTION REDUCTION IN MULTI-RAT DUAL-CONNECTIVITY (MR-DC)

(71) Applicant: MEDIATEK INC., Hsinchu City (TW)

(72) Inventors: Yuanyuan Zhang, Beijing (CN); Chia-Chun Hsu, Hsinchu City (TW)

(21) Appl. No.: 17/369,886

(22) Filed: Jul. 7, 2021

Related U.S. Application Data
(63) Continuation of application No. PCT/CN2020/073138, filed on Jan. 20, 2020.
(60) Provisional application No. 62/799,125, filed on Jan. 31, 2019.

(51) Int. Cl. H04W 36/00; H04W 36/32; H04W 76/30; H04W 74/08

(52) U.S. Cl. CPC H04W 36/0069; H04W 74/0833; H04W 76/30; H04W 36/32

(57) ABSTRACT

Apparatus and methods are provided for mobility interruption reduction with multi-RA dual-connectivity (MR-DC). In novel aspect, the UE with configured transceiver data with at least one source nodes, suspends data transceiving with the first source node upon receiving a reconfiguration message from one of the source nodes, keeps data transceiving with the second source node when accessing a first target node, wherein the second source node is one of the source nodes with active data transceiving with the UE, and suspends data transceiving with the second source node when accessing a second target node if configured. In some embodiments, the UE either keeps the source SN or the source MN while accessing the target MN or target SN by suspending the source MN or source SN.

### CROSS REFERENCE TO RELATED APPLICATIONS

This application is filed under 35 U.S.C. § 111(a) and is based on and hereby claims priority under 35 U.S.C. § 120 and § 365(c) from International Application PCT/CN2020/073138, with an international filing date of Jan. 20, 2020, which in turn claims priority from U.S. Provisional Application No. 62/799,125. This application is a continuation of International Application No. PCT/CN2020/073138, which claims priority from U.S. Provisional Application No. 62/799,125. International Application No. PCT/CN2020/073138 is pending as of the filing date of this application, and the United States is a designated state in International Application No. PCT/CN2020/073138. This application claims priority under 35 U.S.C. § 119 from U.S. Provisional Application No. 62/799,125, entitled “METHODS AND APPARATUS TO REDUCE MOBILITY INTERRUPTION IN MR-DC” filed on Jan. 31, 2019. The disclosure of each of the foregoing documents is incorporated herein by reference.

### TECHNICAL FIELD

The disclosed embodiments relate generally to wireless communication, and, more particularly, to mobility interruption reduction in multi-RAT dual connectivity (MR-DC).

### BACKGROUND

In the current wireless communication network, handover procedure is performed to support mobility when UE moves among different cells. For example, in the current new radio (NR) system, only basic handover is introduced. The basic handover is mainly based on LTE handover mechanism in which network controls UE mobility based on UE measurement reporting. In the basic handover, similar to LTE, source gNB triggers handover by sending HO request to target gNB and after receiving ACK from the target gNB, the source gNB initiates handover by sending HO command with target cell configuration is applied with target cell configurations.

5G introduces multi-RAT dual connectivity (MR-DC) functions. Interruption during Handover is defined as the shortest time duration supported by the system during which a user terminal cannot exchange user plane packets with any base station during mobility transitions. In NR, Oms interruption is one of the requirements to provide seamless handover UE experience. Mobility interruption is one of the most important performance metrics for NR. Therefore, it is important to identify handover solution to achieve high handover performance with Oms or close to Oms interruption, low latency and high reliability.

Improvements and enhancements are required to reduce mobility interruption.

### SUMMARY

Apparatus and methods are provided for mobility interruption reduction with MR-DC. In novel aspect, the UE with MR-DC configured transceiver data with at least one source nodes, suspends data transceiving with the first source node upon receiving a reconfiguration message from one of the source nodes, keeps data transceiving with the second source node when accessing a first target node, wherein the second source node is one of the source nodes with active data transceiving with the UE, and suspends data transceiving with the second source node before accessing a second target node when configured. In one embodiment, the UE suspends data transceiving with the source secondary node (SN), keeps data transceiving with the source master node (MN) when performing random access towards the target MN. In one embodiment, the UE releases a secondary cell group (SCG) configuration; and removing the source SN. In another embodiment, the UE suspends data transceiving with the source MN, keeps data transceiving with the source SN when performing random access towards the target SN. In one embodiment, the UE resumes data transmission with the source MN upon releasing connection with the source SN. In yet another embodiment, UE keeps data transceiving with the source MN when performing random access towards the target MN and suspends data transceiving with the source MN when accessing towards the target SN. In one embodiment, the UE releases a connection with the source MN to suspend data transceiving with the second source node. In one other embodiment, the UE suspends data transceiving with the source SN, keeps data transceiving with the source MN when performing random access towards the target MN, and subsequently suspends data transceiving with the source MN when accessing towards the target SN. In one embodiment, the UE releases the source MN to suspend data transceiving with the second source node. In another embodiment, the UE releases the source SN to suspend data transceiving with the first source node. In yet another embodiment, the UE suspends data transceiving with the source MN, keeps data transceiving with the source SN when performing random access towards the target MN, and subsequently suspends data transceiving with the source SN when accessing towards the target SN. In one embodiment, the UE releases the source MN to suspend data transceiving with the second source node.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network with mobility interruption reduction in MR-DC in accordance with embodiments of the current invention.

FIG. 2 illustrates exemplary diagrams for different scenarios for MR-DC mobility interruption reduction in accordance with embodiments of the current invention.

FIG. 4 illustrates an exemplary flow chart of an MR-DC handover procedure with MN change and SN change in accordance with embodiments of the current invention.

FIG. 5 illustrates an exemplary flow chart of an MR-DC handover procedure with MN change without SN change in accordance with embodiments of the current invention.

FIG. 6 illustrates an exemplary flow chart of an MR-DC handover procedure with SN change in accordance with embodiments of the current invention.

FIG. 7 illustrates exemplary diagrams of top-level handover procedure for MR-DC and different scenarios in accordance with embodiments of the current invention.

FIG. 8 illustrates an exemplary flow chart for mobility interruption reduction with MR-DC in accordance with embodiments of the current invention.

### DETAILED DESCRIPTION

Reference will now be made in detail to some embodiments of the invention, examples of which are illustrated in the accompanying drawings.

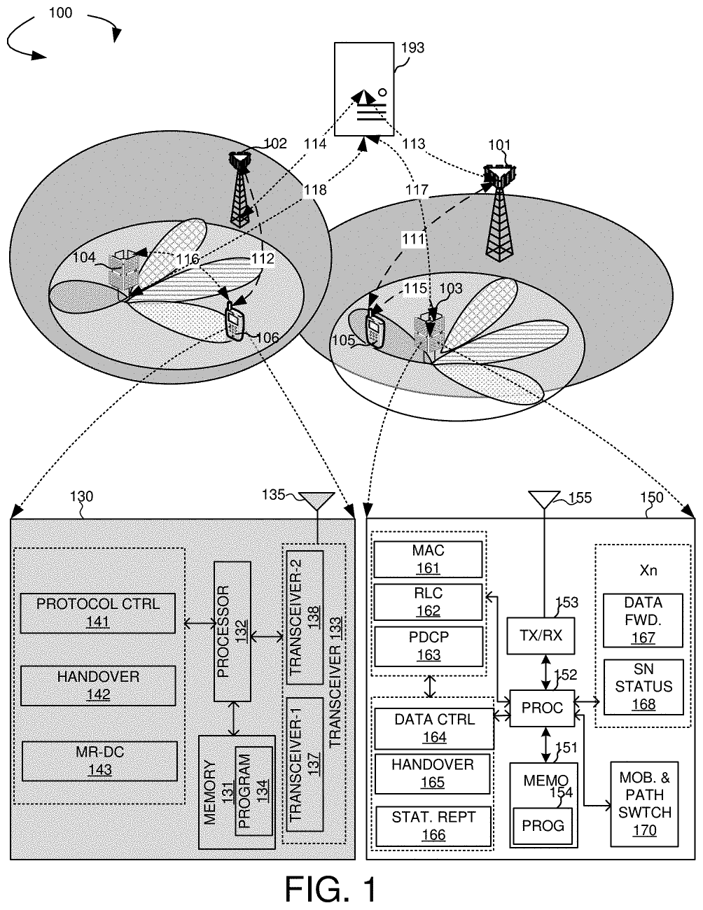

FIG. 1 is a schematic system diagram illustrating an exemplary wireless network with mobility interruption reduction in MR-DC in accordance with embodiments of the current invention. Wireless system 100 includes one or more fixed base infrastructure units forming a network distributed over a geographical region. The base unit may also be referred to as an access point, an access terminal, a base station, a Node-B, an eNode-B, a gNB, or by other terminology used in the art. The network can be homogeneous network or heterogeneous network, which can be deployed with the same frequency or different frequency. The frequency used to provide coverage can be on low frequency e.g. sub-6 GHz or on high frequency e.g. above-6 GHz. As an example, base stations (BSs) 101, 102, 103, 104 serve a number of mobile stations (MSs, or referred to as UEs) 105 and 106 within a serving area, for example, a cell, or within a cell sector. In some systems, one or more base stations are coupled to a controller forming an access network that is coupled to one or more core networks. All the base stations can be adjusted as synchronous network, which means that that the transmission at the base stations are synchronized in time. On the other hand, asynchronous transmission between different baes stations is also supported. The base stations such as 101 and 102 are macro base stations, which provide large coverage. It is either a gNB, eNB or an ng-eNB, which providing NR user plane/E-UTRA and control plane protocol terminations towards the UE. The gNBs and ng-eNBs are interconnected with each other by means of the Xn interfaces. The gNBs and ng-eNBs are also connected by means of the NG interfaces to the 5GC, more specifically to the AMF 193 (Access and Mobility Management Function) by means of the NG-C interface, such as connections 114, 113, 117, and 118 and to the UPF (User Plane Function) by means of the NG-U interface. UE 105 is moving, which is originally served by gNB 101 through the radio link 111. The cell served by gNB 101 is considered as the serving cell. When UE 105 moves among different cells, the serving cell needs to be changed through handover (HO) and the radio link between the UE and the network changes. All other cells instead of the serving cell is considered as neighboring cells, which can either be detected by UE or configured by the network. Among those neighboring cells, one or multiple cells are selected by the network as candidate cells, which are potentially used as the target cell. The target cell is the cell towards which HO is performed. For example, the cell of gNB 103 is considered as the target cell. After HO, the connection between UE and the network is changed from gNB 101 to gNB 103. The original serving cell is considered as source cell. In order to reduce the mobility interruption during HO, it is possible that UE can be connected to both gNB 101 and gNB 103 simultaneously for a while and keeps data transmission with the source cell even if the connection with the target cell has been established.

The gNB 101 and gNB 102 are base station, providing coverage of small cells. They may have a serving area overlapped with a serving area of gNB 101, as well as a serving area overlapped with each other at the edge. They can provide coverage through single beam operation or multiple beam operation. The coverage of the gNBs 101 and 102 can be scalable based on the number of TRPs radiate the different beams. For example, UE or mobile station 105 is in the service area of gNB 101 and connected with gNB 101 via a link 111. UE 105 may also connect with gNB 103 via link 115. Similarly, UE 106 may connect with gNB 102 via link 112 and connect with gNB 104 via link 116.

FIG. 1 further illustrates simplified block diagrams 130 and 150 for UE 106 and gNB 103, respectively. Mobile station 106 has an antenna 135, which transmits and receives radio signals. A RF transceiver circuit 133, coupled with the antenna, receives RF signals from antenna 135, converts them to baseband signal, and sends them to processor 132. In one embodiment, the RF transceiver 133 comprises two RF modules 137 and 138, first RF module 137 is used for a first RF standard, such as an mmW transmitting and receiving, and the second RF module 138 is used for different frequency bands transmitting and receiving which is different from the first RF module 137. RF transceiver 133 also converts received baseband signals from processor 132, converts them to RF signals, and sends out to antenna 135. Processor 132 processes the received baseband signals and invokes different functional modules to perform features in mobile station 107. Memory 131 stores program instructions and data 134 to control the operations of mobile station 107.

Mobile station 106 also includes multiple function modules that carry out different tasks in accordance with embodiments of the current invention. A protocol controller 141 controls the establishment, re-establishment, association and release of the dual protocol stack as well as establishment, re-establishment/reset, association and release of each layer/entity, including the MAC entity, radio link control (RLC) entity, packet data convergence protocol (PDCP) entity, and the service data adaptation protocol (SDAP) entity. A handover controller 142 handles the interruption-reduction/multi-RAT dual connectivity handover procedures for the UE. Handover controller 142 processes the HANDOVER REQ and HANDOVER RESPONSE message for the handover execution, handover failure handling, handover completion procedures and PDCP reordering procedures. MR-DC module 143 controls MR-DC related handover decisions. In one novel aspect, the UE during handover, maintains one data transceiving while accessing the target base stations. In doing so, the UE may suspend a source connection before a random-access (RA) procedure to a target base station. Once a connection with the target base station is established, the UE can suspend the then-active data transceiving source link and access the second target node. In maintaining one active data transceiving path, the mobility interruption is reduced.

Similarly, gNB 103 has an antenna 155, which transmits and receives radio signals. A RF transceiver circuit 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in gNB 103. Memory 151 stores program instructions and data 154 to control the operations of gNB 103. gNB 103 also has MAC 161, RLC 162, PDCP 163 and an SDAP layer. The protocol/data controller 164 controls the (re)establishment and release of the protocol both the network side and UE side. gNB 101 also conveys the control information through RRC message, such as the RRC reconfiguration message to the UE. A handover module 165 handles handover procedures for gNB 103. A PDCP status report module 166 controls the status report procedure.

gNB 103 also includes multiple function modules for Xn interface that carry out different tasks in accordance with embodiments of the current invention. A sequence number status transfer modular 168 transfers the uplink PDCP sequence number and hyper frame number (HFN) receiver status and the downlink PDCP sequence number and HFN transmitter status from the source to the target gNB during an Xn handover for each respective RBs for which PDCP sequence number and HFN status preservation applies. In one embodiment of interruption-optimized HO, the sequence number status transfer performed just after HANDOVER REQUEST ACKNOWLEDGE message is received. In another embodiment of interruption-optimized HO, the sequence number N status transfer procedure is performed once again upon the source sends the RRC connection release message towards the UE. A data forwarding modular 167 of the source base station may forward in order to the target base station all downlink PDCP SDUs with their sequence number that have not been acknowledged by the UE. In addition, the source base station may also forward without a PDCP sequence number fresh data arriving from the CN to the target base station. A mobility and path switching modular 170 controls Xn initiated HO and path switching procedure over the NG-C interface. The handover completion phase for Xn initiated handovers comprises the following steps: the PATH SWITCH message is sent by the target gNB to the AMF when the UE has successfully been transferred to the target cell. The PATH SWITCH message includes the outcome of the resource allocation. The AMF responds with the PATH SWITCH ACK message which is sent to the gNB. The MME responds with the PATH SWITCH FAILURE message in case a failure occurs in the 5GCN.

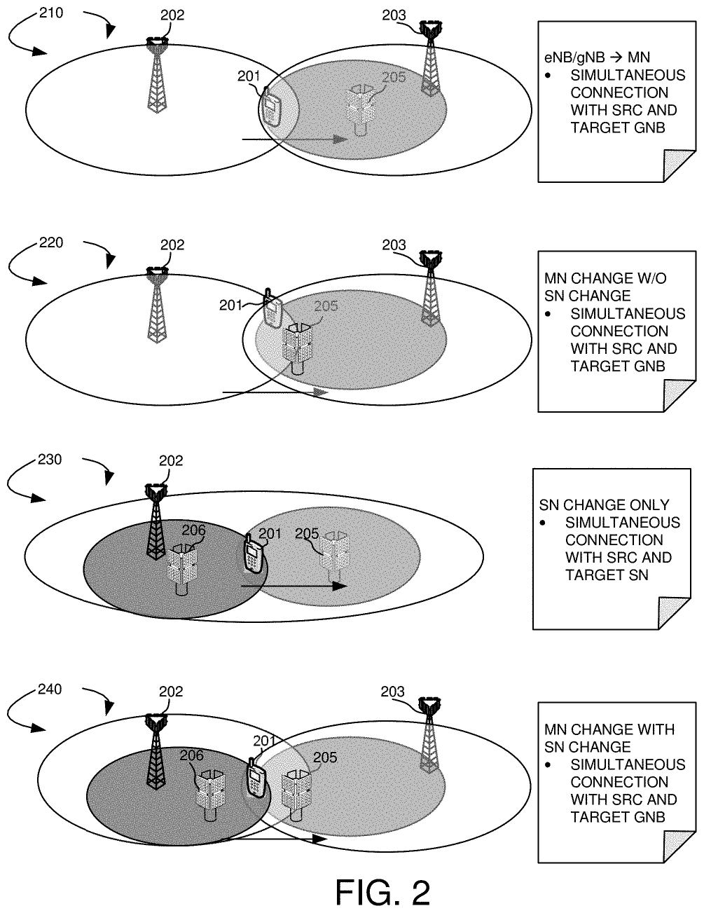

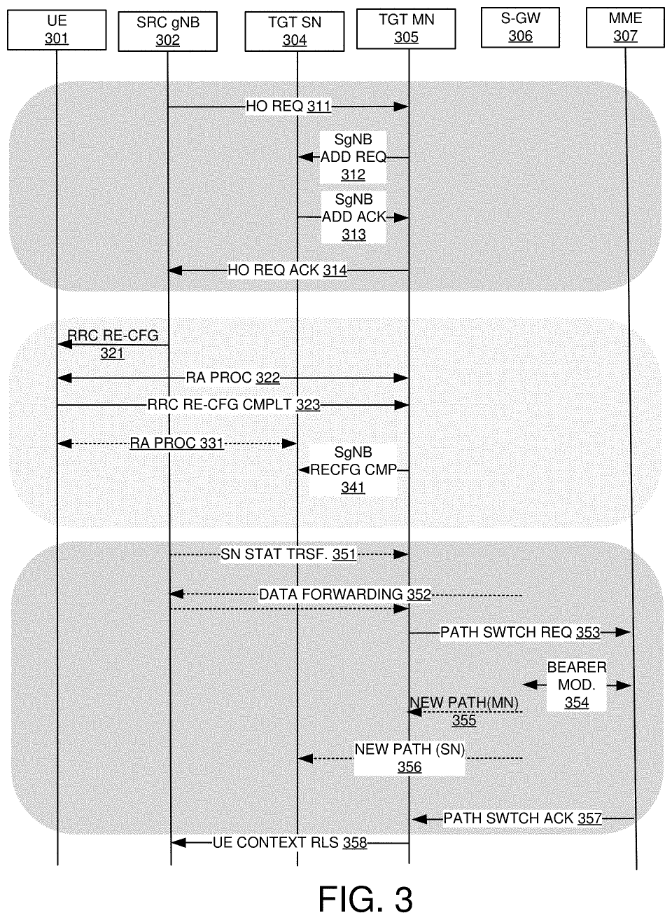

FIG. 2 illustrates exemplary diagrams for different scenarios for MR-DC mobility interruption reduction in accordance with embodiments of the current invention. With MR-DC enabled, the system is designed to achieve low or zero mobility interruption. In the MR-DC, there are master nodes (MN) and secondary nodes (SN). In general, the master nodes function as the controlling entity. The secondary nodes are used for additional data capacities. Before the handover, the UE may have data transmission and reception with the source MN, the source SN or both the source MN and the source SN. The target base station may be the target MN or the target SN. Depending the configuration and the deployment, different handover scenarios may apply in the MR-DC system. In scenario 210, the UE changes from source MN to target MN and target SN. UE 201 is connected with source MN 202. The target cell has a target MN 203 and a target SN 205. During handover, UE 202 makes data transfer from source MN 202 to target MN 203 and target SN 205. In scenario 220, the UE changes MN without SN update. UE 201 is connected with source MN 202 and target 205. The target cell has a target MN 203 and a target SN 205. During handover, UE 201 makes data transfer from source MN 202 to target MN 203. Since UE 202 is already exchanging with target SN 205, there is no change of SN for the handover procedure. In scenario 230, the UE changes SN only. UE 201 is connected with source MN 202 and source SN 206. As UE 201 moves, the UE performs handover to new SN 205 without changing MN. After SN change, UE 201 connects with MN 202 and SN 205. In scenario 240, the UE changes MN and SN. UE 201 connects with source MN 202 and source SN 206. UE 201 changes MN and SN during the handover. After the handover, UE 201 connects with MN 203 and SN 205.

FIG. 3 illustrates an exemplary flow chart of an MR-DC handover procedure with MN change in accordance with embodiments of the current invention. In one scenario, the UE changes MN during the handover. Simultaneous connectivity is required with both source gNB and the target gNB during the handover. After connection with target gNB is established, RA procedure towards SN is required when UE performs simultaneous Tx/Rx with the source or/and target gNB. In one embodiment, the UE releases/suspends the source connection first and initiate RA towards the target SN. In another embodiment, the UE adds the target SN after the handover is completed.

The UE connected in the wireless network with serving gateway (S-GW) 306 and MME 307. At step 311, source MN 302 sends handover request to target MN 305. At step 312, target MN 305 sends secondary gNB addition request to target SN 304. At step 313, target SN 304 sends secondary gNB addition ACK back to target MN 305. At step 314, target MN 305 sends handover request ACK to source MN 302. Upon receiving the handover request ACK from the target MN, at step 321, source MN 302 sends RRC Connection Reconfiguration to UE 301. Subsequently, at step 322, UE starts random access to target MN 305 based on the received RRC Connection Reconfiguration message. Upon successful random access, UE 301 at step 323, sends RRC Connection Reconfiguration Complete message to target MN 305. In one embodiment, UE continues data transmission/reception with the source MN when performing RA procedure towards the target MN. Upon successful connection with target MN 305, UE 301 releases the connection with the source MN and performs random access to target SN 304 at step 331. In another embodiment, UE 301 establishes connection with target SN 304 after the completion of the handover procedure to the target MN 305. At step 341, upon successful random access to target MN 305, target MN 305 sends secondary gNB reconfiguration complete message to target SN 304. Upon successful connection with the target, the network modifies the data path. At step 351, source MN 302 sends sequence number status transfer to target MN 305. At step 351, source MN 302 starts data forwarding through S-GW 306 to target MN 305. At step 353, target MN 305 sends path switch message to MME 307. At step 354, S-GW 306 and MME 307 exchanges bearer modification. At step 355, S-GW 306 sends new path (MN) to target MN 305. At step 356, S-GW 306 sends new path (SN) to target SN 304. Upon new data path establishing, at step 357, MME 307 sends path switch ACK to target MN 305. Subsequently, target MN 305 sends UE context release message at step 358.

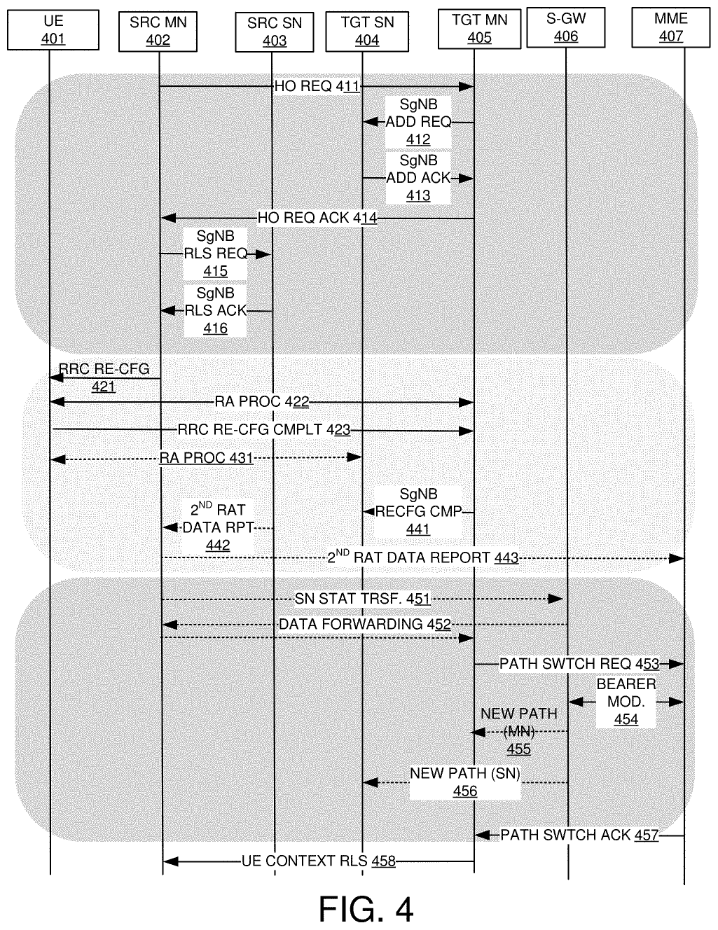

FIG. 4 illustrates an exemplary flow chart of an MR-DC handover procedure with MN change and SN change in accordance with embodiments of the current invention. In one scenario, the UE changes MN during the handover. Simultaneous connectivity is required with both source gNB and the target gNB during the handover. After connection with target gNB is established, RA procedure towards SN is required when UE performs simultaneous Tx/Rx with the source or/and target gNB. In one embodiment, the UE releases the source connection first and initiates RA towards the target SN.

The UE connected in the wireless network with serving gateway (S-GW) 406 and MME 407. At step 411, source MN 402 sends handover request to target MN 405. At step 412, target MN 405 sends secondary gNB addition request to target SN 404. At step 413, target SN 404 sends secondary gNB addition ACK back to target MN 405. At step 414, target MN 405 sends handover request ACK to source MN 402.

Since UE 401 has data connection with both the source MN and the source SN, to reduce mobility interruption, the UE will release one data connection while keeping another data connection during random access to the target. Upon receiving the handover request ACK from the target MN, at step 415, source MN 402 sends secondary gNB release request to source SN 403. At step 416, source SN 403 sends source gNB release ACK to source MN 402. At step 421, source MN 402 sends RRC Connection Reconfiguration to UE 401. Subsequently, at step 422, UE starts random access to target MN 405 based on the received RRC Connection Reconfiguration message. Upon successful random access, UE 401 at step 423, sends RRC Connection Reconfiguration Complete message to target MN 405. In one embodiment, upon successful connection with target MN 405, UE 401 suspends the data transmission/reception with the source MN and performs random access to target SN 304 at step 431. In another embodiment, UE 301 establishes connection with target SN 404 after the completion of the handover procedure to the target MN 405. At step 441, upon successful random access to target MN 405, target MN 405 sends secondary gNB reconfiguration complete message to target SN 404. In one embodiment, at step 442, source SN 403 sends secondary RAT data volume report to source MN 402. At step 443, source MN 402 sends secondary RAT Report to MME 407.

Upon successful connection with the target, the network modifies the data path. At step 451, source MN 402 sends sequence number status transfer to target MN 405. At step 451, source MN 402 starts data forwarding through S-GW 406 to target MN 405. At step 453, target MN 405 sends path switch message to MME 407. At step 454, S-GW 406 and MME 407 exchanges bearer modification. At step 455, S-GW 406 sends new path (MN) to target MN 405. At step 456, S-GW 406 sends new path (SN) to target SN 404. Upon new data path establishing, at step 457, MME 407 sends path switch ACK to target MN 405. Subsequently, target MN 405 sends UE context release message to source MN 402 at step 458.

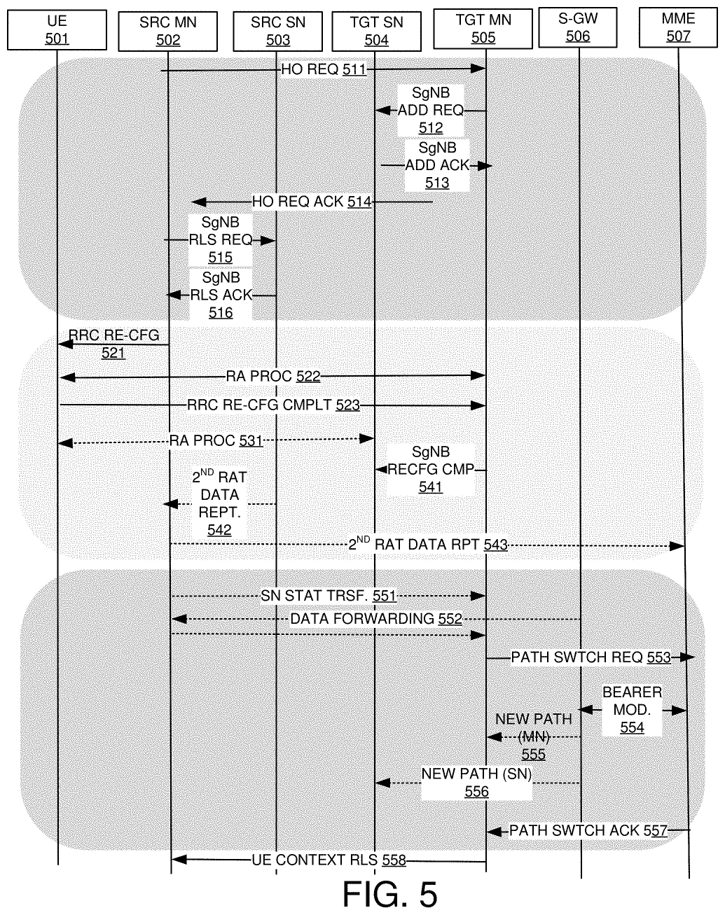

FIG. 5 illustrates an exemplary flow chart of an MR-DC handover procedure with MN change without SN change in accordance with embodiments of the current invention. In this scenario, simultaneous connectivity is required with both source gNB and the target gNB during handover. Connectivity with SN should be kept when UE performs RA procedure towards the target and thereafter. In a first embodiment, the UE suspends data transceiving with SN. In one embodiment, the suspended data transceiving is reassumed upon releasing of the source connection. In a second embodiment, the UE continues data transceiving with SN without support of simultaneous connectivity with source and target. The suspended CG/DRB are indicated. In a third embodiment, the UE to releases SN during handover and adds SN later after the completion of the handover.

In this scenario, the source SN 503 and target SN 504 is the same SN. The UE connected in the wireless network with serving gateway (S-GW) 506 and MME 507. At step 511, source MN 502 sends handover request to target MN 505. At step 512, target MN 505 sends source gNB addition request to target SN 504. At step 513, target SN 504 sends source gNB addition ACK back to target MN 505. At step 514, target MN 505 sends handover request ACK to source MN 502.

Upon receiving the handover request ACK from the target MN, at step 515, source MN 502 sends secondary gNB release request to source SN 503. At step 516, source SN 503 sends secondary gNB release ACK to source MN 502. In this scenario, source SN 503 and target SN 504 are the same SN. In this embodiment, the UE releases the current connection with the SN and reestablishes a link with the SN. At step 521, source MN 502 sends RRC Connection Reconfiguration to UE 501. Subsequently, at step 522, UE starts random access to target MN 505 based on the received RRC Connection Reconfiguration message. Upon successful random access, UE 501 at step 523, sends RRC Connection Reconfiguration Complete message to target MN 505. In one embodiment, upon successful connection with target MN 505, UE 501 performs random access to target SN 504 at step 531. In another embodiment, UE 501 establishes connection with target SN 504 after the completion of the handover procedure to the target MN 505. In yet another embodiment, since the source SN and the target SN is the same SN, the UE suspends the data transceiving with the SN first, and resumes the data transceiving with the SN upon detecting one or more predefined events. In one embodiment, the predefined event is upon releasing the source connection. At step 541, upon successful random access to target MN 505, target MN 505 sends secondary gNB reconfiguration complete message to target SN 504. In one embodiment, at step 542, source SN 503 sends secondary RAT data volume report to source MN 502. At step 543, source MN 502 sends secondary RAT Report to MME 507.

Upon successful connection with the target, the network modifies the data path. At step 551, source MN 502 sends sequence number status transfer to target MN 505. At step 551, source MN 502 starts data forwarding through S-GW 506 to target MN 505. At step 553, target MN 505 sends path switch message to MME 507. At step 554, S-GW 506 and MME 507 exchanges bearer modification. At step 555, S-GW 506 sends new path (MN) to target MN 505. At step 556, S-GW 506 sends new path (SN) to target SN 504. Upon new data path establishing, at step 557, MME 507 sends path switch ACK to target MN 505. Subsequently, target MN 505 sends UE context release message to source MN 502 at step 558.

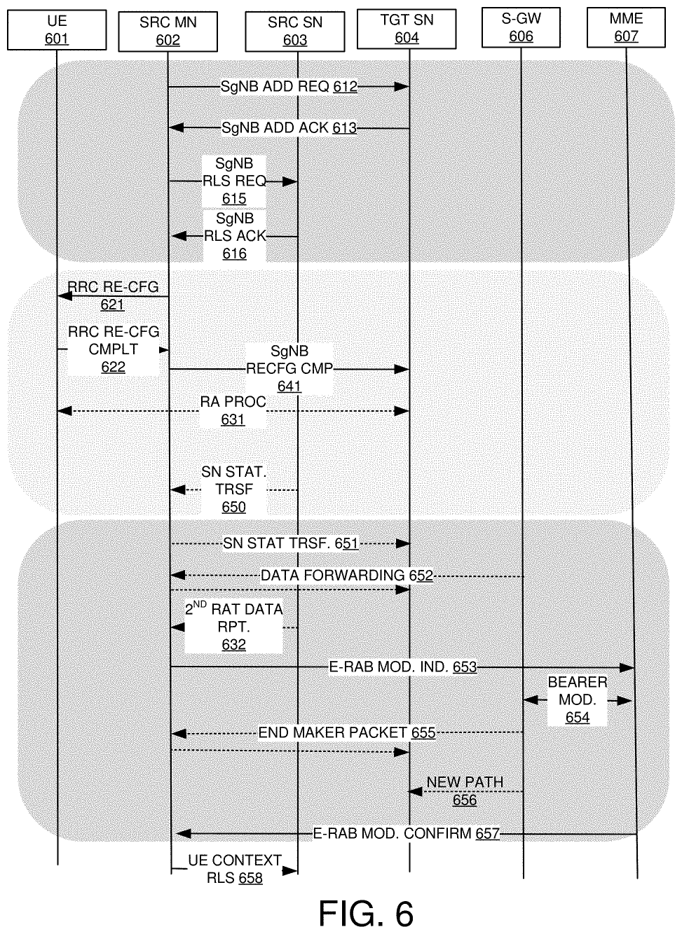

FIG. 6 illustrates an exemplary flow chart of an MR-DC handover procedure with SN change in accordance with embodiments of the current invention. For the SN change, simultaneous connectivity is required with both source SN and the target SN during SN change. Meanwhile, connectivity with MN should be kept. In one embodiment, the UE suspends data transmission/reception with MN. In another embodiment, no simultaneous connectivity with both source SN and target SN for SN change.

The UE connected in the wireless network with serving gateway (S-GW) 606 and MME 607. At step 612, source MN 602 sends secondary gNB addition request to target SN 604. At step 613, target SN 604 sends secondary gNB addition ACK back to source MN 602. At step 615, source MN 602 sends secondary gNB release request to source SN 603. At step 616, source SN 603 sends source gNB release ACK source MN 602. At step 621, source MN 602 sends RRC Connection Reconfiguration to UE 601. Subsequently, at step 622, UE sends RRC Connection Reconfiguration Complete message to source MN 602. At step 641, upon successful random access to target SN 604, source MN 602 sends secondary gNB reconfiguration complete message to target SN 604.

Upon successful connection with the target, the network modifies the data path. At step 650, source SN 603 sends SN status transfer message to source MN 602. At step 651, source MN 602 sends SN status transfer to target SN 604. At step 652, source MN 602 starts data forwarding through S-GW 606 to target MN 605. At step 653, source MN 602 sends E-RAB modification indication to MME 607. At step 654, S-GW 606 and MME 607 exchanges bearer modification. At step 655, S-GW 606 sends end maker packet with source MN 602 and target SN 604. At step 656, S-GW 606 sends new path (SN) to target SN 604. Upon new data path establishing, at step 657, MME 607 sends E-RAB modification confirmation to source MN 602. Subsequently, source MN 602 sends UE context release message to source SN 603 at step 658.

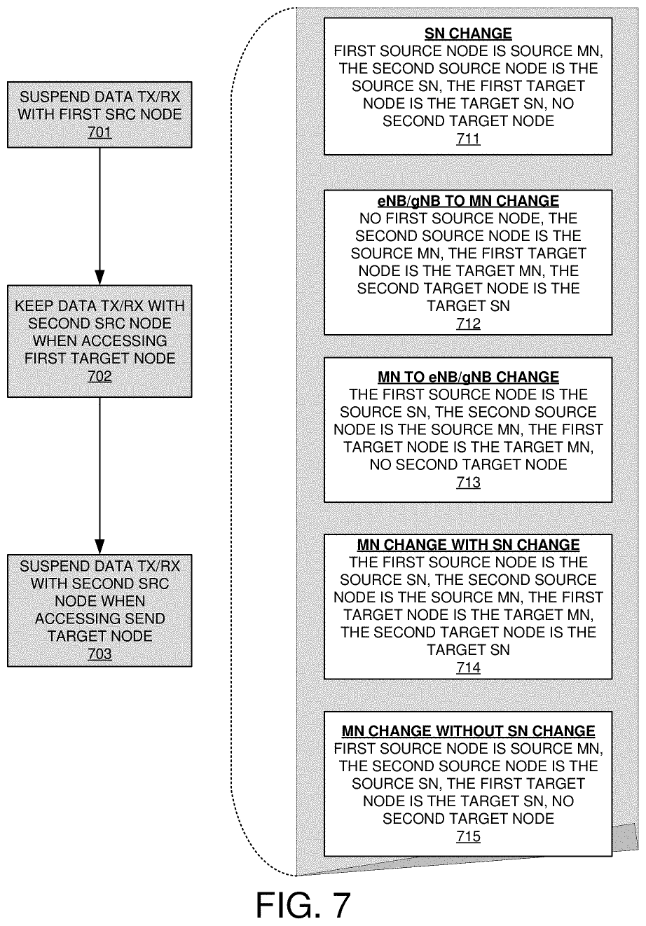

FIG. 7 illustrates exemplary diagrams of top-level handover procedure for MR-DC and different scenarios in accordance with embodiments of the current invention. As illustrated in details above, there are different scenarios during handover for the MR-DC enabled UE. In order to reduce the mobility interruption, the UE should keep at least one data transceiver during handover while accessing the target cells. In particular, at step 701, the UE suspends data transceiving with the first source node. At step 702, the UE keeps data transceiving with the second source node when accessing towards the first target node. At step 703, the UE suspends transceiving with the second source node when accessing towards the second target node. With the general principle of keep one data path during handover procedure, the UE can reduce mobility interruption for different scenarios as shown. For scenario 711, SN change case, the first source node is source MN, the second source node is the source SN, the first target node is the target SN, no second target node configured. For scenario 712, eNB/gNB to MN change case, there is no first source node, the second source node is the source MN, the first target node is the target MN, the second target node is the target SN. For scenario 713, MN to eNB/gNB change: the first source node is the source SN, the second source node is the source MN, the first target node is the target MN, no second target node. For scenario 714, MN change with SN change case, the first source node is the source SN, the second source node is the source MN, the first target node is the target MN, the second target node is the target SN. For scenario 715, MN change without SN change case, first source node is source MN, the second source node is the source SN, the first target node is the target SN, no second target node.

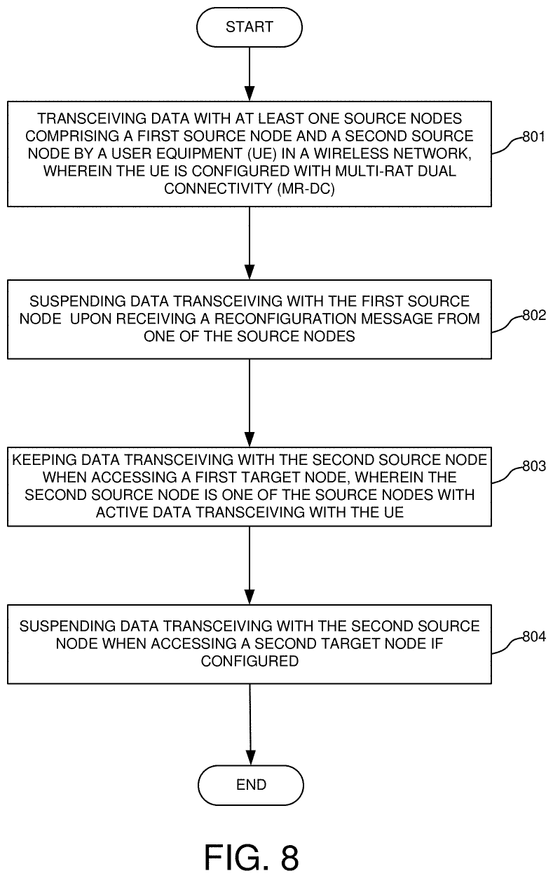

FIG. 8 illustrates an exemplary flow chart for mobility interruption reduction with MR-DC in accordance with embodiments of the current invention. At step 801, the UE transceiver data with at least one source nodes comprising a first source node and a second source node in a wireless network, wherein the UE is configured with MR-DC. At step 802, the UE suspends data transceiving with the first source node upon receiving a reconfiguration message from one of the source nodes. At step 803, the UE keeps data transceiving with the second source node when accessing a first target node, wherein the second source node is one of the source nodes with active data transceiving with the UE. At step 804, the UE suspends data transceiving with the second source node before accessing a second target node if configured.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
transceiving data with at least one source nodes comprising a first source node and a second source node by a user equipment (UE) in a wireless network, wherein the UE is configured with multi-RAT dual connectivity (MR-DC);
suspending data transceiving with the first source node upon receiving a reconfiguration message from one of the source nodes;
keeping data transceiving with the second source node when accessing a first target node, wherein the second source node is one of the source nodes with active data transceiving with the UE; and
suspending data transceiving with the second source node when accessing a second target node if configured.

2. The method of claim 1, wherein the first source node is a source secondary node (SN), the second source node is a source master node (MN), the first target node is a target MN, and the second target node is not configured, and wherein the UE suspends data transceiving with the source SN, keeps data transceiving with the source MN when performing random access towards the target MN.

3. The method of claim 2, further comprising: releasing a secondary cell group (SCG) configuration; and removing the source SN.

4. The method of claim 1, wherein the first source node is a source secondary node (SN), the second source node is a source master node (MN), the first target node is a target SN, and the second target node is not configured, and wherein the UE suspends data transceiving with the source MN, keeps data transceiving with the source SN when performing random access towards the target SN.

5. The method of claim 4, further comprising: resuming data transmission with the source MN upon releasing connection with the source SN.

6. The method of claim 1, wherein the first source node is not configured, the second source node is a source master node (MN), the first target node is a target MN, and the second target node is a target secondary node (SN), and wherein the UE keeps data transceiving with the source MN when performing random access towards the target MN and suspends data transceiving with the source MN when accessing towards the target SN.

7. The method of claim 6, wherein the UE releases a connection with the source MN to suspend data transceiving with the second source node.

8. The method of claim 1, wherein the first source node is a source secondary node (SN), the second source node is a source master node (MN), the first target node is a target MN, and the second target node is a target SN, and wherein the UE suspends data transceiving with the source SN, keeps data transceiving with the source MN when performing random access towards the target MN, and subsequently suspends data transceiving with the source MN when accessing towards the target SN.

9. The method of claim 8, wherein the UE releases the source MN to suspend data transceiving with the second source node.

10. The method of claim 8, wherein the UE releases the source SN to suspend data transceiving with the first source node.

11. The method of claim 1, wherein the first source node is a source master node (MN), the second source node is a source secondary node (SN), the first target node is a target MN, and the second target node is a target SN, and wherein the UE suspends data transceiving with the source MN, keeps data transceiving with the source SN when performing random access towards the target MN, and subsequently suspends data transceiving with the source SN when accessing towards the target SN.

12. The method of claim 11, wherein the UE releases the source MN to suspend data transceiving with the second source node.

13. A user equipment (UE), comprising:
a transceiver that transmits and receives radio frequency (RF) signal in a wireless network;
a memory; and
a processor coupled to the memory, the processor configured to transceive data with at least one source nodes comprising a first source node and a second source node, configure the UE with multi-RAT dual connectivity (MR-DC); suspend data transceiving with the first source node upon receiving a reconfiguration message from one of the source nodes; keep data transceiving with the second source node when accessing a first target node, wherein the second source node is one of the source nodes with active data transceiving with the UE; and suspend data transceiving with the second source node before accessing a second target node if configured.

14. The UE of claim 13, wherein the first source node is a source secondary node (SN), the second source node is a source master node (MN), the first target node is a target MN, and the second target node is not configured, and wherein the UE suspends data transceiving with the source SN, keeps data transceiving with the source MN when performing random access towards the target MN.

15. The UE of claim 14, wherein the UE releases a secondary cell group (SCG) configuration; and removing the source SN.

16. The UE of claim 13, wherein the first source node is a source secondary node (SN), the second source node is a source master node (MN), the first target node is a target SN, and the second target node is not configured, and wherein the UE suspends data transceiving with the source MN, keeps data transceiving with the source SN when performing random access towards the target SN.

17. The UE of claim 16, wherein the UE resumes data transmission with the source MN upon releasing connection with the source SN.

18. The UE of claim 13, wherein the first source node is not configured, the second source node is a source master node (MN), the first target node is a target MN, and the second target node is a target secondary node (SN), and wherein the UE keeps data transceiving with the source MN when performing random access towards the target MN and suspends data transceiving with the source MN when accessing towards the target SN.

19. The UE of claim 18, wherein the UE releases a connection with the source MN to suspend data transceiving with the second source node.

20. The UE of claim 13, wherein the first source node is a source secondary node (SN), the second source node is a source master node (MN), the first target node is a target MN, and the second target node is a target SN, and wherein the UE suspends data transceiving with the source SN, keeps data transceiving with the source MN when performing random access towards the target MN, and subsequently suspends data transceiving with the source MN when accessing towards the target SN.

21. The UE of claim 20, wherein the UE releases the source MN to suspend data transceiving with the second source node.

22. The UE of claim 20, wherein the UE releases the source SN to suspend data transceiving with the first source node.

23. The UE of claim 13, wherein the first source node is a source master node (MN), the second source node is a source secondary node (SN), the first target node is a target MN, and the second target node is a target SN, and wherein the UE suspends data transceiving with the source MN, keeps data transceiving with the source SN when performing random access towards the target MN, and subsequently suspends data transceiving with the source SN when accessing towards the target SN.

24. The UE of claim 23, wherein the UE releases the source MN to suspend data transceiving with the second source node.
